(19) United States
(12) Patent Application Publication
(10) Pub. No.: US 2019/0168598 A1
(43) Pub. Date: Jun. 6, 2019

(54) ELECTRIC VEHICLE

(71) Applicant: TOYOTA JIDOSHA KABUSHIKI KAISHA, Toyota-shi (JP)

(72) Inventor: Hiroyuki HATTORI, Okazaki-shi (JP)

(73) Assignee: TOYOTA JIDOSHA KABUSHIKI KAISHA, Toyota-shi (JP)

(21) Appl. No.: 16/199,557

(22) Filed: Nov. 26, 2018

(30) Foreign Application Priority Data
Dec. 1, 2017 (JP) 2017-232066

(51) Int. Cl. B60K 6/26

(52) U.S. Cl. CPC B60K 6/26; B60W 20/11

(57) ABSTRACT

To suppress occurrence of a counter electromotive force due to a permanent magnet motor, in an electric vehicle that includes a permanent magnet motor and a non-permanent magnet motor rotating a drive shaft. An electric vehicle includes a permanent magnet type PM motor that rotates a front wheel drive shaft. The PM motor and the drive shaft are connected and disconnected by a clutch. The electric vehicle also includes a non-permanent magnet type SR motor that rotates a rear wheel drive shaft. When the clutch disconnects the PM motor and the drive shaft, the SR motor rotates the drive shaft.

### CROSS REFERENCE TO RELATED APPLICATION

The disclosure of Japanese Patent Application No. 2017-232066 filed on Dec. 1, 2017 including the specification, claims, drawings, and abstract is incorporated herein by reference in its entirety.

### TECHNICAL FIELD

The present disclosure relates to an electric vehicle including a permanent magnet motor and a non-permanent magnet motor.

### BACKGROUND

As a motor for rotationally driving an electric vehicle, in some cases, both of a permanent magnet motor in which a permanent magnet is embedded in a rotor and a non-permanent magnet motor in which no permanent magnet is embedded in a rotor are used.

Each of JP 2005-178479 A, JP 2007-230366 A, and JP 2007-325352 A describes a hybrid electric vehicle that includes a permanent magnet motor and a non-permanent magnet motor rotating a drive shaft, and is driven in cooperation with an internal combustion engine.

In the electric vehicle of JP 2005-178479 A, driving force is selected so that at least the non-permanent magnet motor rotates the drive shaft at low speed, and the permanent magnet motor rotates the drive shaft at high speed. In other words, the non-permanent magnet motor is used only when a large driving force is required, such as at the time of starting.

In the description of the electric vehicle of JP 2007-230366 A, the non-permanent magnet motor is used for assistance at the time of travel on a hill, starting, and slippage, for example.

In the electric vehicle of JP 2007-325352 A, the non-permanent magnet motor is used to drive a rear wheel which is an idler wheel, and is not used as a drive source at high speed.

### SUMMARY

### Technical Problem

In JP 2005-178479 A, JP 2007-230366 A, and JP 2007-325352 A, the non-permanent magnet motor is used in a secondary manner for rotation at low speed. Generally, in a non-permanent magnet motor, only a small counter electromotive force occurs while driving. Additionally, even when the non-permanent magnet motor is co-rotated by a torque from the drive shaft, occurrence of a counter electromotive force is prevented if no electric power is supplied thereto.

Since a counter electromotive force occurs in proportion to speed in a permanent magnet motor, power output is deteriorated during high-speed driving. Additionally, since a counter electromotive force occurs when the permanent magnet motor is co-rotated by a torque from the drive shaft, too, drag loss increases. A large counter electromotive force may induce failure in parts of an inverter when there is trouble in rotation control, for example.

It is an advantage of the present disclosure to suppress occurrence of a counter electromotive force due to a permanent magnet motor, in an electric vehicle that includes a permanent magnet motor and a non-permanent magnet motor rotating a drive shaft.

### Solution to Problem

An electric vehicle according to an embodiment of the present disclosure includes: a permanent magnet motor that rotates a drive shaft; a clutch that connects and disconnects the permanent magnet motor and the drive shaft; and a non-permanent magnet motor that rotates the same drive shaft or a different drive shaft. When the clutch disconnects the permanent magnet motor and the drive shaft, the non-permanent magnet motor rotates the same or a different drive shaft.

The electric vehicle is driven only by the permanent magnet motor or the non-permanent magnet motor. Note, however, that the electric vehicle may have another permanent magnet motor or non-permanent magnet motor mounted therein as another drive source. The electric vehicle may also be a hybrid electric vehicle also including an internal combustion engine.

The permanent magnet motor is a rotary electromotor in which a permanent magnet is mounted on a rotor. The non-permanent magnet motor is a rotary electromotor in which no permanent magnet is mounted on a rotor. The rotary electromotors may have only the powering function, or may have a regeneration function in addition to the powering function.

The drive shaft is a rotating shaft that is connected to a wheel and transmits a torque to the wheel. One or multiple drive shafts may be provided. When there are multiple drive shafts, they may or may not be connected. The multiple drive shafts may be connected through a gear mechanism to function as a series of drive shafts, for example. Instead, a front wheel drive shaft and a rear wheel drive shaft may be provided separately without being connected to each other, for example. The permanent magnet motor and the non-permanent magnet motor may drive a series of connected drive shafts, or may each drive a separate drive shaft.

The clutch connects and disconnects the permanent magnet motor and the drive shaft. When the clutch is connected, torque can be transmitted from the permanent magnet motor to the drive shaft, and when the clutch is disconnected, the torque transmission is shut off.

In the electric vehicle, when the clutch disconnects the permanent magnet motor and the drive shaft, the non-permanent magnet motor performs driving. When the clutch is connected, both the permanent magnet motor and the non-permanent magnet motor may perform driving, or the permanent magnet motor alone may perform driving, for example.

In an aspect of the present disclosure, at low speed, the clutch is connected and at least the permanent magnet motor performs driving, and at high speed, the clutch is disconnected and the non-permanent magnet motor performs driving. Note that the speed at which to transition from connection to disconnection of the clutch and the speed at which to transition from disconnection to connection of the clutch may be the same or may be different.

In an aspect of the present disclosure, the permanent magnet motor drives either one of a front wheel drive shaft for driving front wheels and a rear wheel drive shaft for driving rear wheels, the non-permanent magnet motor drives the other of the front wheel drive shaft and the rear wheel drive shaft, and the front wheel drive shaft and the rear wheel drive shaft are not connected and are provided separately.

In an aspect of the present disclosure, the drive shaft is any either of a front wheel drive shaft for driving front wheels and a rear wheel drive shaft for driving rear wheels, and the permanent magnet motor and the non-permanent magnet motor rotate the same drive shaft selected from either the front wheel drive shaft for driving front wheels or the rear wheel drive shaft for driving rear wheels.

### Advantageous Effects of Invention

According to an aspect of the present disclosure, when driving is not performed by the permanent magnet motor, the permanent magnet motor is cut off from the drive shaft, so that occurrence of a counter electromotive force due to co-rotation can be prevented, and drag loss can be suppressed. Additionally, when there is trouble in rotation control, for example, failure in parts of an inverter that supplies electric power to the permanent magnet motor can be prevented.

According to an aspect of the present disclosure, it is possible to achieve both a large-torque characteristic by enabling driving of at least by the permanent magnet motor at low speed, and a high-efficiency and high-power output characteristic by disabling driving by the permanent magnet motor and enabling driving by the non-permanent magnet motor at high speed.

### BRIEF DESCRIPTION OF DRAWINGS

Embodiments of the present disclosure will be described by reference to the following figures, wherein:

FIG. 1 is a view showing a schematic configuration example of an electric vehicle of the embodiment;

FIG. 2 is a view exemplifying a characteristic of a PM motor related to speed and torque;

FIG. 3 is a view exemplifying a characteristic of an SR motor related to speed and torque;

FIG. 4 is a view exemplifying a characteristic of the electric vehicle of the embodiment related to speed and torque;

FIG. 5 is a view showing a schematic configuration of an electric vehicle of a modification; and

FIG. 6 is a view showing a schematic configuration of an electric vehicle of another modification.

### DESCRIPTION OF EMBODIMENTS

Hereinafter, embodiments will be described with reference to the drawings. Although specific forms will be shown in the description to facilitate understanding, these are examples of embodiments, and various other embodiments may be made.

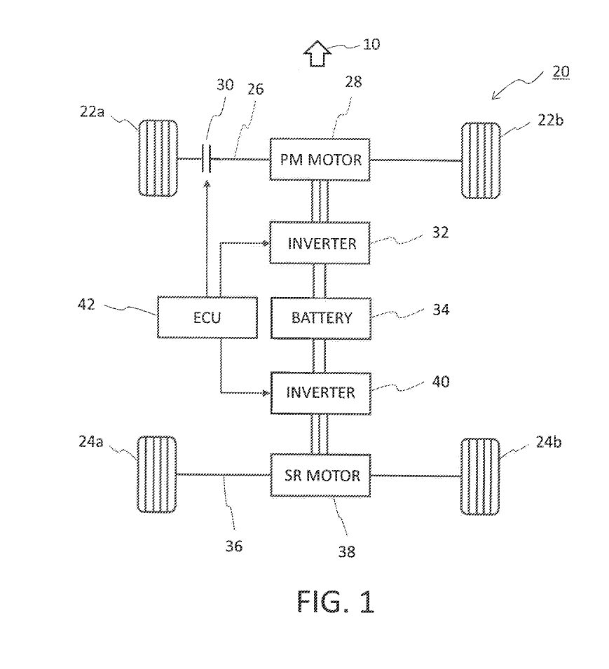

FIG. 1 is a view showing a schematic configuration of an electric vehicle 20 of the embodiment. The electric vehicle 20 is a four-wheeled vehicle whose front direction is indicated by an arrow 10, and includes two front wheels 22a, 22b, and two rear wheels 24a, 24b. The front wheels 22a, 22b are connected to a drive shaft 26. A PM motor 28 that rotates the drive shaft 26 is attached to the drive shaft 26. The PM motor 28 is a permanent magnet motor in which a permanent magnet is embedded in a rotor. A clutch 30 is provided in the drive shaft 26. Although simplified in FIG. 1, the clutch 30 is a device that connects and disconnects the PM motor 28 and the drive shaft 26. That is, when the clutch 30 is connected, torque can be transmitted from the PM motor 28 to the front wheels 22a, 22b through the drive shaft 26. Then, when the clutch 30 is disconnected, torque transmission from the PM motor 28 to the front wheels 22a, 22b is shut off.

The PM motor 28 is a three-phase motor, and is supplied with a three-phase AC power in which phases are shifted by 120 degrees by an inverter 32. The inverter 32 is formed of multiple semiconductor devices, and is configured to convert a DC current supplied from a battery 34 into a three-phase AC current by switching of the semiconductor devices, and to supply the three-phase AC current to the PM motor 28.

The rear wheels 24a, 24b are connected to a drive shaft 36. An SR motor 38 is attached to the drive shaft 36. The SR motor 38 is a switched reluctance motor, and is a non-permanent magnet motor in which no permanent magnet is mounted on a rotor. There is no clutch provided between the SR motor 38 and the drive shaft 36, and the two are connected directly. A three-phase AC power is supplied to the SR motor 38 from an inverter 40. The inverter 40 is provided separately from the aforementioned inverter 32, and is configured to convert DC power supplied from the battery 34 into an AC power according to a control form of the SR motor 38.

The electric vehicle 20 is also provided with an ECU (electric control unit) 42. The ECU 42 includes computer hardware that has a computing function, and software such as a program and data that causes the hardware to operate. The ECU 42 receives input of a detection signal from various sensors (e.g., a speed sensor and a temperature sensor) which are omitted from FIG. 1, and controls operation of parts of the electric vehicle 20 based on software. The inverters 32, 40, and the clutch 30 are control targets of the ECU 42 shown in FIG. 1.

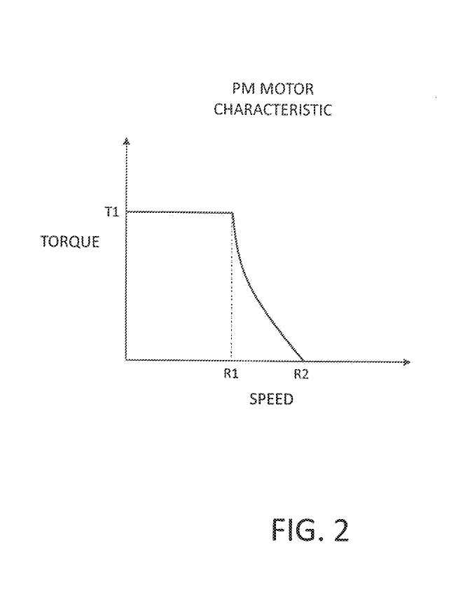

Hereinafter, a characteristic of the PM motor 28 will be described with reference to FIG. 2. FIG. 2 is a view in which the horizontal axis indicates speed and the vertical axis indicates torque, and schematically showing a relationship between speed and torque in the PM motor 28. When the speed is lower than R1 (vehicle is at low speed), the torque of the PM motor 28 is kept substantially constant at torque T1. However, when the speed is higher than R1 (vehicle is at high speed), the torque rapidly decreases with speed, and the torque is substantially zero at speed R2. Then, when the speed exceeds R2, the PM motor cannot contribute to driving of the drive shaft 26.

The PM motor 28 is provided with a permanent magnet mounted on the rotor, and can increase torque by increasing the magnetic force of the permanent magnet. Meanwhile, a counter electromotive force proportionate to the magnitude of the magnetic force of the permanent magnet occurs in the PM motor 28. Since the counter electromotive force increases also in proportion to speed, power output deteriorates at high speed. Accordingly, to suppress counter electromotive force at high speed, the magnetic field generated by the permanent magnet needs to be cancelled out by supplying a field weakening current. However, this increases loss.

Note that in the PM motor 28, a drag loss proportionate to the intensity of the permanent magnet occurs even when no load is applied thereto. That is, when power supply to the PM motor 28 from the inverter 32 is stopped while the PM motor 28 is connected to the drive shaft 26, rotation of the rotor generates a counter electromotive force proportionate to the strength of the permanent magnet. Occurrence of a large counter electromotive force may cause trouble such as ineffective control, which may induce failure in parts of the inverter 32.

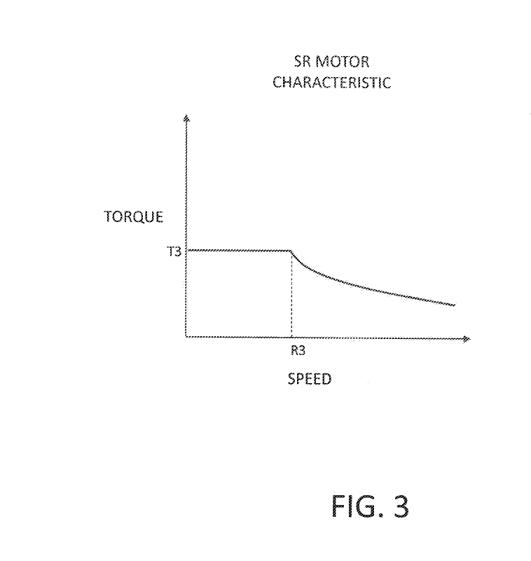

FIG. 3 is a view schematically showing a characteristic of the SR motor 38 related to speed and torque. In the SR motor 38, when the speed is lower than R3, the torque is kept substantially constant at torque T3. This torque T3 is smaller than torque T1 of the PM motor 28. When the speed is higher than R3, the torque gradually decreases, but does not reach zero even at a sufficiently high speed. Thus, the SR motor 38 can produce a generally stable torque from low speed to high speed. In particular, the SR motor 38 is characterized in that it can output a large power (output power is proportionate to the product of speed and torque) at high speed.

Since the SR motor 38 has no permanent magnet mounted on the rotor, the generated counter electromotive force is smaller than that in the PM motor 28. Hence, the SR motor 38 is capable of efficient driving even at high speed. Moreover, in the SR motor 38, even when power supply from the inverter 40 is stopped while the SR motor 38 is directly connected to the drive shaft 36, counter electromotive force due to co-rotation does not occur.

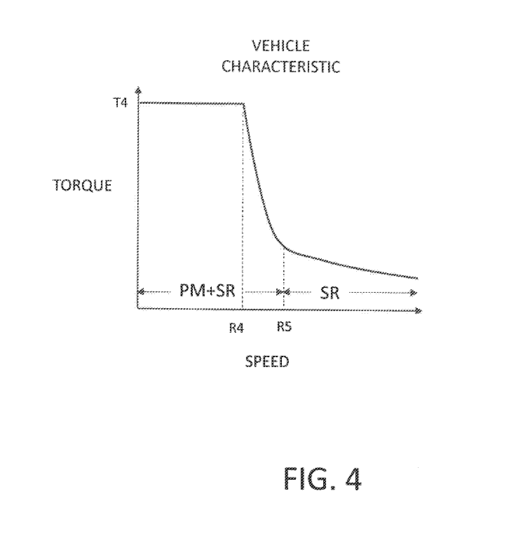

Next, motor control in the electric vehicle 20 will be described with reference to FIG. 4. FIG. 4 is a view schematically showing a characteristic of the electric vehicle 20 of the embodiment related to speed and torque. As described with reference to FIG. 1, the electric vehicle 20 includes two motors which are the PM motor 28 and the SR motor 38, and has the ECU 42 controlling the inverters 32, 40. The ECU 42 also controls connection and disconnection of the clutch 30.

As shown in FIG. 4, when the speed is lower than R5, the electric vehicle 20 is driven by the two motors of PM motor 28 and SR motor 38. At this time, when the speed is lower than R4 (about the same speed as speed R1 and speed R3), and the PM motor 28 and SR motor 38 produce the same torque as when they are driving on their own, torque T4 is the sum of torque T1 and torque T3.

In the region where the speed is higher than R4, the torque decreases rapidly. This reflects the rapid decrease in torque of the PM motor 28 at a higher speed than R1, and the decrease in torque of the SR motor 38 at a higher speed than R3. Note, however, that both of the PM motor 28 and SR motor 38 are used for driving in a region where the speed is lower than around R5 (higher than speed R4, and lower than speed R2 of FIG. 2).

When the speed increases further, and reaches R5, the ECU 42 disconnects the clutch 30 and cuts off the PM motor 28 from the drive shaft 26. That is, when the speed is higher than R5, the driving is performed by the SR motor 38 alone. As a result, in FIG. 4, in the region where the speed is higher than R5, the torque is substantially the same as the torque of the SR motor 38 in FIG. 3. Note that after cutting off the PM motor 28 from the drive shaft 26, the ECU 42 shuts off the energization circuit from the inverter 32 to the PM motor 28, and stops the power supply.

When the speed lowers from a value higher than R5 to a value lower than R5, the ECU 42 resumes power supply from the inverter 32 to the PM motor 28, and connects the clutch 30. This restarts the driving by both of the PM motor 28 and SR motor 38. Note, however, that if the clutch 30 is disconnected and connected at the same speed, connection and disconnection of the clutch 30 is repeated and will cause unstable operation when the vehicle runs at around this speed. Hence, the speed at which to connect the clutch 30 is set slightly lower than the speed at which to disconnect the clutch 30.

When the clutch 30 is connected, the ECU 42 performs control to produce the same torque as when both the PM motor 28 and SR motor 38 are driving on their own, and when the clutch 30 is disconnected, the ECU 42 performs control to produce the same torque as when the SR motor 38 is driving on its own. However, in this case, the torque may change discontinuously, or even when the torque is continuous, the torque may fail to shift smoothly around speed R5. Accordingly, before and after disconnection or connection of the clutch 30, the ECU 42 may perform control to enable continuous changing of the magnitude of the torque, or enable smooth shifting of the torque. This control is performed by adjusting one or both of the torques of the PM motor 28 and the SR motor 38. FIG. 4 shows a case where the torque is continuous and shifts smoothly before and after connection and disconnection of the clutch 30.

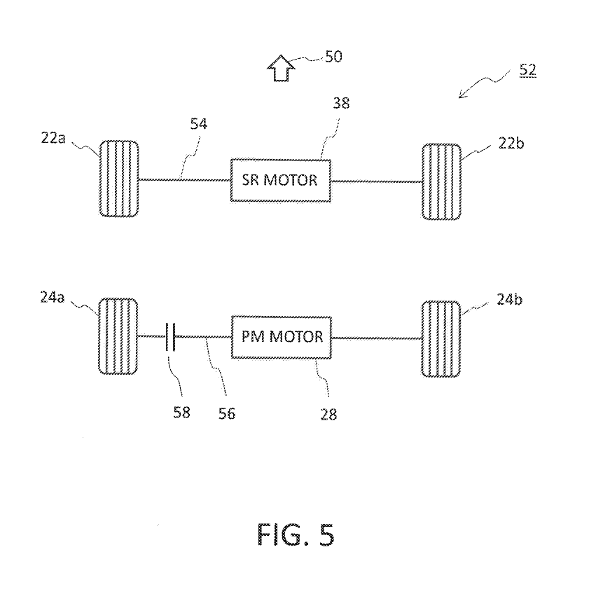

Next, a modification will be described with reference to FIG. 5. FIG. 5 is a view showing a schematic configuration of an electric vehicle 52 of a modification. The electric vehicle 52 is a vehicle whose front direction is indicated by an arrow 50. FIG. 5 is a view corresponding to FIG. 1, and corresponding configurations are assigned the same reference numerals. In addition, the inverter, battery, and ECU are omitted from FIG. 5.

In the electric vehicle 52, an SR motor 38 is attached to a drive shaft 54 connected to front wheels 22a, 22b. Additionally, a PM motor 28 is attached to a drive shaft 56 connected to rear wheels 24a, 24b. Also, a clutch 58 that connects and disconnects transmission of torque from the PM motor 28 is provided in the drive shaft 56.

In the electric vehicle 52, the SR motor 38, the PM motor 28, and the clutch 58 are controlled in the same manner as in the electric vehicle 20 shown in FIG. 1. That is, at low speed, the clutch 58 is connected to enable driving by both of the PM motor 28 and the SR motor 38. Then, at high speed, the clutch 58 is disconnected to enable driving by the SR motor 38 alone. Accordingly, all four wheels are driven at low speed, and only the rear wheels are driven at high speed. This is in contrast to the aforementioned electric vehicle 20 where all four wheels are driven at low speed and only the front wheels are driven at high speed.

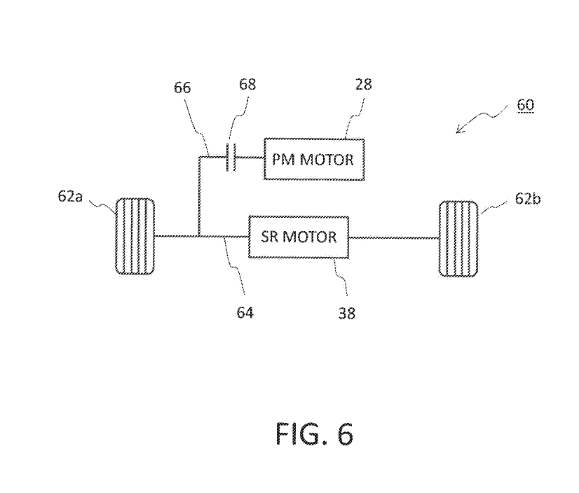

FIG. 6 is a view for describing an electric vehicle 60 of another modification. Although the electric vehicle 60 is a four-wheeled vehicle, wheels 62a, 62b on only one side of the front or rear wheels are shown in FIG. 6. A drive shaft 64 and another drive shaft 66 connected to the drive shaft 64 are connected to the wheels 62a, 62b. The drive shaft 64 is driven by an SR motor 38. Although the drive shaft 66 is driven by a PM motor 28, the PM motor 28 can be connected and disconnected by a clutch 68. That is, when the clutch 68 is connected, the PM motor 28 drives the drive shaft 66, and the drive shaft 66 drives the drive shaft 64. When the clutch 68 is disconnected, the PM motor 28 does not contribute to driving.

In the electric vehicle 60, the other two of the four wheels are not driven by a motor. Hence, when the wheels 62a, 62b are front wheels, the electric vehicle 60 is a front-wheel-drive car, and when the wheels 62a, 62b are rear wheels, the electric vehicle 60 is a rear-wheel-drive car. The PM motor 28, the SR motor 38, and the clutch 68 are controlled in the same manner as in the electric vehicle 20 of FIG. 1 and the electric vehicle 52 of FIG. 5. That is, at low speed, the clutch 68 is connected to enable driving of the drive shafts 64, 66 by both of the PM motor 28 and the SR motor 38. Then, at high speed, the clutch 68 is disconnected to enable driving by the SR motor 38 alone.

In the above description, both of the PM motor 28 and SR motor 38 are driven when the speed is lower than speed R5. However, when the speed is lower than speed R5, it is also possible to energize only the PM motor 28 for use in driving, and the SR motor 38 may be left unenergized and be not used for driving. Also, when the speed is lower than speed R5, it is also possible to use the PM motor 28 alone for driving in a normal state, and use both the PM motor 28 and SR motor 38 for driving only when a large torque is required. Examples of cases requiring a large torque include starting of a vehicle (starting from a stopped state and until reaching a predetermined speed) and traveling an uphill road. Whether to use both the PM motor 28 and SR motor 38 or the PM motor 28 alone at low speed may be determined on the basis of whether the required torque can be ensured.

In FIG. 4, speed R5 at which to cut off the PM motor 28 is assumed to be set higher than speed R4 and lower than speed R2 of FIG. 2. With this, it is possible to both utilize the large drive torque produced by the PM motor 28 at low speed, and avoid deterioration in efficiency due to counter electromotive force at high speed. If a large torque is required even at the expense of some efficiency, the PM motor 28 may be cut off in a region higher than speed R5 shown in FIG. 4. Note, however, that at a speed higher than speed R2 shown in FIG. 2, the PM motor 28 can hardly produce torque, and drag loss increases. Hence, the PM motor 28 is preferably cut off at a speed lower than speed R2. Meanwhile, when efficiency is more important, the PM motor 28 may be cut off in a region where a speed is lower than speed R5 shown in FIG. 4. In either case, the characteristics related to speed and torque shown in FIGS. 2 to 4 are schematic, and the characteristics are actually a little more complex. In such cases, too, the control timing of the clutch can be determined from the viewpoint of ensuring of required torque and energy efficiency.

Hereinabove, descriptions have been given from the viewpoint of using the PM motor 28 and the SR motor 38 for driving. However, generally, in an electric vehicle, energy efficiency can be enhanced by providing a regeneration function of converting kinetic energy of the vehicle into electric energy in the course of deceleration. Accordingly, one or both of the PM motor 28 and the SR motor 38 may be formed of a motor generator also used as a generator to implement the regeneration function. Instead, a generator may be provided separately from the PM motor 28 and the SR motor 38. Even when the PM motor 28 is used as a motor generator, the PM motor 28 may be cut off from the drive shaft during high-speed driving to prevent drag loss and enhance energy efficiency. When the PM motor 28 is used as a motor generator, in order to generate power during deceleration, the PM motor 28 needs to be connected to the drive shaft. Hence, at the time of deceleration, the PM motor 28 may be connected to the drive shaft at a higher speed than the speed at which the PM motor 28 is cut off while driving. Note, however, that the speed at which to connect to the drive shaft is preferably a speed at which durability of parts of the inverter 32 against counter electromotive force can be sufficiently ensured.

In the above description, an electric vehicle has been assumed to be driven by the PM motor 28 and the SR motor 38. However, the electric vehicle includes a hybrid vehicle including an internal combustion engine that burns gasoline or the like. While such an electric vehicle including another drive source has different overall torque characteristics as a vehicle, the embodiment controlling the PM motor 28 and the SR motor 38 is still applicable.

### REFERENCE SIGNS LIST

10, 50 arrow, 20, 52, 60 electric vehicle, 22a, 22b front wheel, 24a, 24b rear wheel, 26, 36, 54, 56, 64, 66 drive shaft, 28 PM motor, 30, 58, 68 clutch, 32, 40 inverter, 34 battery, 38 SR motor, 42 ECU, 62a, 62b wheel.

1. An electric vehicle comprising:
a permanent magnet motor that rotates a drive shaft;
a clutch that connects and disconnects the permanent magnet motor and the drive shaft; and
a non-permanent magnet motor that rotates the same drive shaft or a different drive shaft, wherein
when the clutch disconnects the permanent magnet motor and the drive shaft, the non-permanent magnet motor rotates the same or a different drive shaft.

2. The electric vehicle according to claim 1, wherein:
at low speed, the clutch is connected and at least the permanent magnet motor performs driving; and
at high speed, the clutch is disconnected and the non-permanent magnet motor performs driving.

3. The electric vehicle according to claim 1, wherein:
the permanent magnet motor drives any either of a front wheel drive shaft for driving front wheels and a rear wheel drive shaft for driving rear wheels;
the non-permanent magnet motor drives the other of the front wheel drive shaft and the rear wheel drive shaft; and
the front wheel drive shaft and the rear wheel drive shaft are not connected and are provided separately.

4. The electric vehicle according to claim 1, wherein:
the drive shaft is either one of a front wheel drive shaft for driving front wheels and a rear wheel drive shaft for driving rear wheels; and
the permanent magnet motor and the non-permanent magnet motor rotate the same drive shaft selected from either the front wheel drive shaft for driving front wheels or the rear wheel drive shaft for driving rear wheels.
